(19) United States
(12) Patent Application Publication
(10) Pub. No.: US 2010/0212124 A1
(43) Pub. Date: Aug. 26, 2010

(54) FISHING LURE URN AND METHOD OF MEMORIALIZING A FISHING ENTHUSIAST

(76) Inventors: Joshua A. DENTON, Camden, SC (US); George Vanmetre Kornegay, JR., Camden, SC (US)

Correspondence Address: JOSHUA A. DENTON, P.O.BOX 92, CAMDEN, SC, 29021, US

(21) Appl. No.: 12/393,122

(22) Filed: Feb. 26, 2009

(51) Int. Cl. A61G 17/08

(52) U.S. Cl. 27/1; 40/722; 40/124.5

(57) ABSTRACT

Provided herein are urns for receipt and storage of the cremated remains of a deceased person, such as a fisherman, the urns having the shape of a fishing lure, and a method of memorializing a deceased person within such an urn. Each urn includes a hollow body having an opening therein, the opening being fitted with a closure device, such as a plug, cap, or slidable door. The present urns permit the surviving relative or friend to cherish the memories of the deceased and to honor the deceased's interests by storing his cremated remains in a urn configured to resemble a fishing lure and by displaying the urn in a stand, a holder, or a shadow box. The urn, stand, or shadow box may be engraved or labeled with the name or initials, birth and death dates or years, or other information about, or messages honoring, the deceased fisherman.

### TECHNICAL FIELD

The present disclosure relates generally to ash containers for cremated human remains (i.e., urns) and particularly to an ash container that is configured in the shape of a fishing lure. In a first instance, the ash container may be displayed on a stand or a holder. In another instance, the ash container may be fitted with a hanging bracket and mounted within a shadow box. A method of memorializing a deceased loved one through the use of such an ash container is also provided.

### BACKGROUND

Fishing is an avocation enjoyed by millions and is often shared among family members. For example, parents and their children may use fishing expeditions as an occasion to spend time together. Whether it be an early morning adventure, the hours spent together in a boat or on a dock, the cleaning of the day's catch, or more mundane tasks such as shopping for fishing gear, the activities associated with fishing result in strong bonds between fishing companions.

Understandably, after sharing countless hours engaged in this pursuit, a fisherman may be emotionally devastated by the death of a fishing companion. In many cases, the dearly departed fishing buddy may be laid to rest in a burial plot, where family members and friends may later visit to pay their respects. In other instances, the deceased may be cremated, in which case the family members may opt to preserve the ashes in a cremation urn or cremation memorial.

Many cremation memorials have been designed to honor the deceased, including urns such as those shown in, for example, U.S. Design Pat. Nos. D356,422 and D360,732. The urns may be displayed in the home of a family member or friend as a reminder of the deceased. In many cases, the urns may be made of brass, bronze, or some other material that may be engraved with the name or other information (such birth and death dates) of the loved one.

Other cremation memorials have been designed for functional purposes for the keeper of the memorial. For example, U.S. Pat. No. 5,029,373 describes a flower vase whose base functions as a container for the cremated remains of a loved one. U.S. Pat. No. 5,208,957 describes a piece of jewelry, such as a pendant, which is configured to hold a small container of ashes. U.S. Pat. No. 5,815,897 preserves the cremated remains in a cremation chamber that forms the base of a cylindrical planter box.

Yet other cremation containers have been designed to reflect the interests of the deceased. For example, U.S. Design Pat. Nos. D356,421 and D370,767 provide urns in the form of lawn ornaments that include images of dolphins and waves. Similarly, U.S. Design Pat. No. D418,271 illustrates a cremation urn shaped in the form of a starfish. U.S. Design Pat. Nos. D370,766 and D370,768 provide cremation storage in the form of lawn ornaments that include images of deer and trees. U.S. Pat. No. 6,662,416 discloses a housing for cremation remains within an artificial underwater reef system, possibly for a scuba enthusiast or an environmentally conscious decedent For the automotive enthusiast, U.S. Pat. No. 6,988,299 provides a cremains storage container is formed within an engine block or engine cylinder. Finally, U.S. Design Pat. No. D524,510 provides a baseball bat urn, in which the knob of the bat is unscrewed and the cremains poured into a cavity inside the bat.

Thus, while many of the aforementioned resting places are creative and may provide an appropriate tribute to the deceased, none provides the type of loving testament that a devoted family member or friend desires for a faithful fishing companion.

### SUMMARY

Provided herein are ash containers, or urns, for receipt and storage of the cremated remains of a deceased person, the ash containers having the shape of a fishing lure, and a method of memorializing a deceased person within such an urn. The ash container includes a hollow body having an opening therein, the opening being fitted with a closure device, such as a plug, cap, or slidable door. In one instance, the ash container may be displayed on a stand or a holder. In another instance, the ash container may be fined with a hanging bracket and mounted within a shadow box. The ash container, stand, or shadow box may be engraved or labeled with the name or initials, birth and death dates or years, or other information about, or messages honoring, the deceased fisherman.

The present urns permit a surviving relative or friend to cherish the memories of the deceased and to honor the deceased's interests by storing his cremated remains in a urn configured to resemble a fishing lure and by displaying the urn in a stand, a holder, or a shadow box.

The method of memorializing includes providing an ash container for housing the cremated remains of a loved one, the ash container being configured in the shape of a fishing lure, being fitted with a closable port, and, optionally, being provided with a mounting bracket; transferring the remains of the loved one into the ash container and sealing the closable port; and displaying the ash container on a stand or a holder or within a shadow box. The method may further include providing information about the loved one on the ash container itself, on the stand or the holder, or on or within the shadow box.

### BRIEF DESCRIPTION OF THE DRAWINGS

A full and detailed description is set forth in the accompanying detailed description, which makes reference to the appended drawings, in which:

FIG. 1 is a side elevational view of a fishing lure urn, according to one aspect of the present disclosure;

FIG. 2A is a side elevational view of another fishing lure urn, according to a second aspect of the present disclosure;

FIG. 2B is a perspective view of the fishing lure urn of FIG. 2A;

FIG. 2C is a cross-sectional view of the fishing lure urn of FIG. 2A, as taken along line 2C-2C;

FIG. 3 is a side elevational view of yet another fishing lure urn;

FIG. 4 is a cross-sectional view of the fishing lure urn of FIG. 3, in which the closure mechanism has been replaced with a slidable door;

FIG. 5 is a back perspective view of another fishing lure urn;

FIG. 6 is a front perspective view of the fishing lure urn of FIG. 5, in which a commemorative plate has been added to the urn;

FIG. 7 is a front perspective view of the fishing lure urn of FIG. 6, as displayed on a stand;

FIG. 8 is a front perspective view of the fishing lure urn of FIG. 6, as displayed within a shadow box;

FIG. 9 is a front perspective view of yet another fishing lure urn, similar in shape to that of FIG. 1, as displayed in a holder; and

FIG. 10 is a front perspective view of the fishing lure urn and holder of FIG. 9, in which a commemorative plate has been added to the holder.

### DETAILED DESCRIPTION

Reference is now made to the drawings for illustration of various components of the present fishing lure urns. The urns are adapted to hold a portion of the cremated remains of a deceased person and are configured to resemble a fishing lure designed to commemorate the interests of the deceased. The urns may be displayed on a stand or a holder or, alternately, may be fitted with a bracket for mounting within a shadow box. While the illustrations provided herein are directed to fishing lure urns of particular shapes, the elements and embodiments may be equally applicable to any of a variety of hollow-body fishing lures. It should be noted that, although the fishing lure urns are shown as having surfaces decorated with different patterns, any painting technique or coloration method may be used to adorn the fishing lure urns.

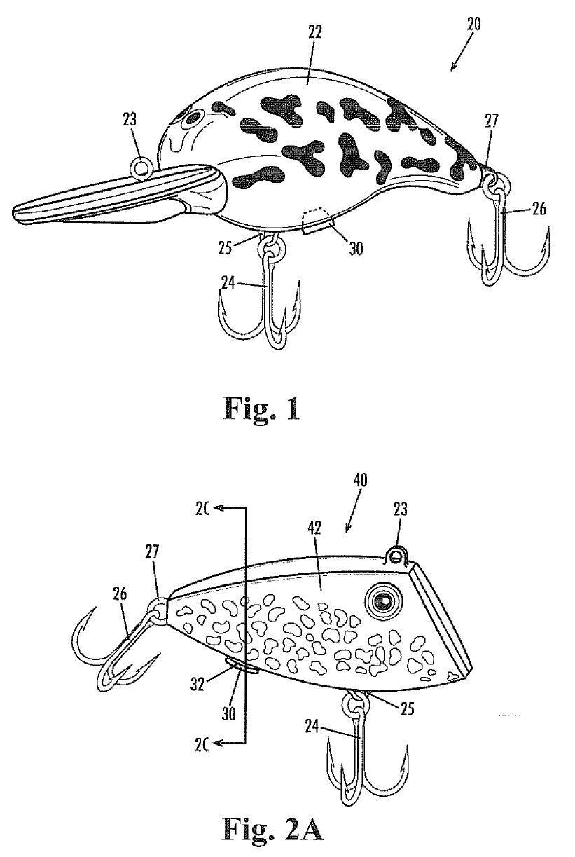

FIG. 1 illustrates a generic fishing lure urn 20 having an elongated hollow body 22 that resembles an underwater creature. The head end of the hollow body 22 may include a eyelet, or wire loop, 23, to which a fishing line would conventionally be attached, although such an eyelet 23 is not required. Projecting from the underside of the hollow body 22 may be an eyelet 25 through which a hook 24 may be attached. Similarly, at the tail end of the hollow body, another eyelet 27 may extend for the carriage of a second hook 26. As will be readily apparent, the hooks 24, 26 may be removed for ease of handling. Alternately, the hooks 24, 26 may be of a different type than those illustrated. In yet another alternative, the eyelets 25, 27 may be located at different locations along the hollow body 22, and different numbers of eyelets may be used, as desired.

An opening may be strategically formed through the underside of the hollow body 22 as a port through which the cremated remains of a loved one may be inserted. The opening may be sealed using a plug-type cap 30, having a size and shape complementary to that of the opening. Such a plug-type cap 30 represents a method of closure that is simple to operate and manufacture. If desired, glue or other adhesive may be applied around the edges of the cap 30 to create a permanent seal, thereby preventing the possibility of the accidental discharge of the urn contents.

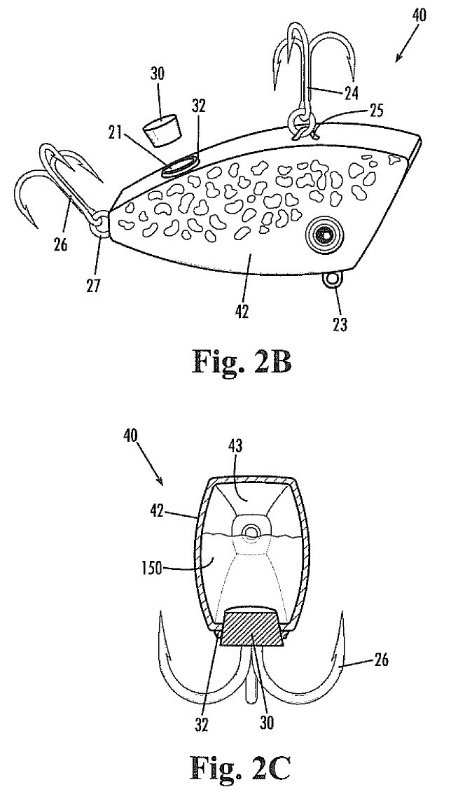

FIGS. 2A through 2C illustrate another representative fishing lure urn 40, also having an elongate hollow body 42, several eyelets 23, 25, 27, and a pair of hooks 24, 26. As with the fishing lure urn 20 of FIG. 1, the hollow body 42 of the fishing lure urn 40 forms a receptacle for receipt of the ashes (150) of a departed loved one. The underside of the fishing lure urn 40 may include a opening 21 (as shown in FIG. 2B), which may be surrounded by a decorative metal or plastic ring 32. A flexible plug-type cap, or stopper, 30 may be used to close the opening 21, after the ashes (120) have been transferred into the urn 40.

FIG. 2C shows a cross-section of the fishing lure urn 40 of FIG. 2A, as taken along line 2C-2C. The interior cavity 43 of the hollow body 42 may be filled to a desired level with the ashes 120 of the decedent, and the opening (21) on the underside of the hollow body 42 may be plugged with the cap 30.

It is anticipated that several family members may be provided with similar fishing lure urns, according to the teachings herein, for display in their respective homes. Alternately, the present fishing lure urn(s) may be used to house a portion of the remains of the deceased, while the larger portion of the remains is stored in an outdoor cremation memorial, a cremation niche, or a more traditional urn.

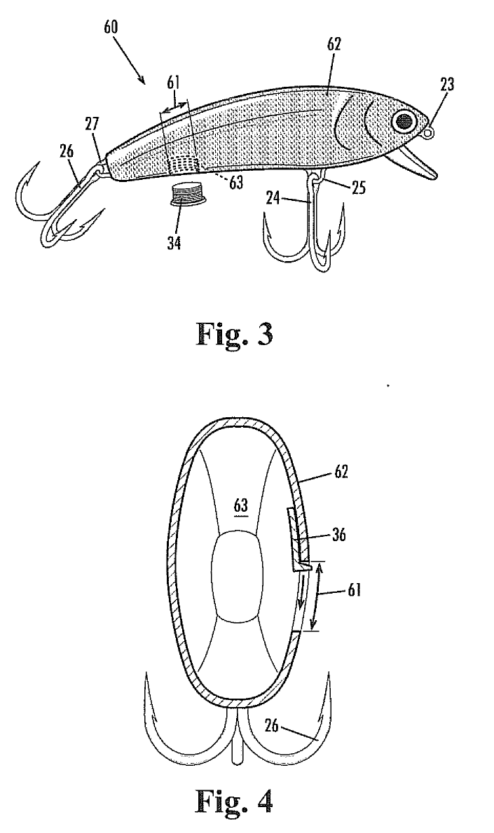

Yet another shape and closure device for the fishing lure urn is shown in FIG. 3 as fishing lure urn 60. The fishing lure urn 60 has the appearance of a small fish, although many other different shapes may instead be used. The closure mechanism for the urn 60 is a screw-type closure, in which a screw cap 34 is used in conjunction with a threaded socket 63 formed within the underside of the hollow body 62 of the urn 60. This threaded socket 63 defines an opening 61, which permits filling of the urn 60.

The screw cap 34 may include any type of screw drive, such as a slotted drive, a Phillips head drive, or a hex screw drive, and may further include any type of screw head shape, such as pan, button, round, or flat. Alternately, the screw cap 34 may be of the type with a raised rib extending from the screw head, which may be used for hand-tightening of the cap 34. In yet another alternative, the threaded socket 63 may project outwardly from the underside of the hollow body 62, and the screw cap 34 may be of the type that encompasses the threaded socket 63 (e.g., as in a tube of toothpaste). Further, the screw cap 34 may be fitted with a glass viewing port, or sight glass, that permits the contents (150) to be viewed without removing the cap 34.

Another type of closure may be seen in FIG. 4, in which the hollow body 62 is configured with a slidable closure, including a sliding door 36 that blocks the opening 61. The sliding door 36 may be opened to expose the cavity 63 for filling and then may be closed to prevent the contents from being dislodged. The sliding door 36 may be located along one side of the urn 60, in which case the side with the sliding door 36 may be considered the back side of the urn 60 (as shown in FIG. 4). Alternately, depending on the shape of the urn 60, the sliding door 36 may be located along the underside of the urn (e.g., 60), in which case the urn 60 may turned upside-down for filling.

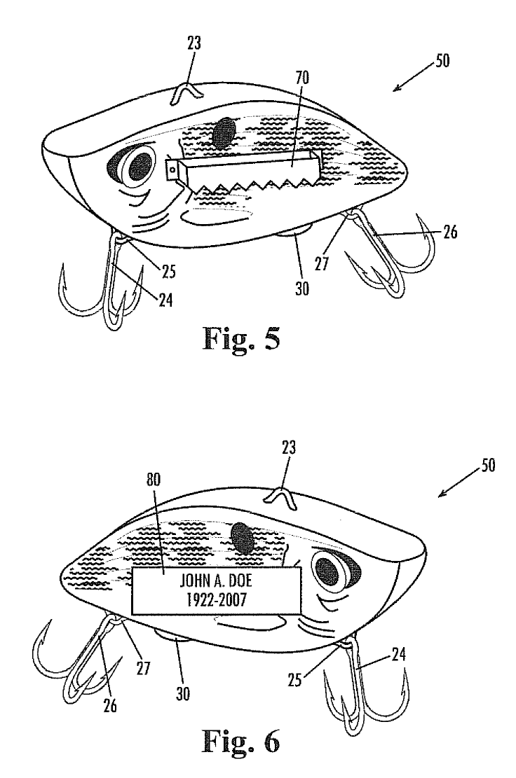

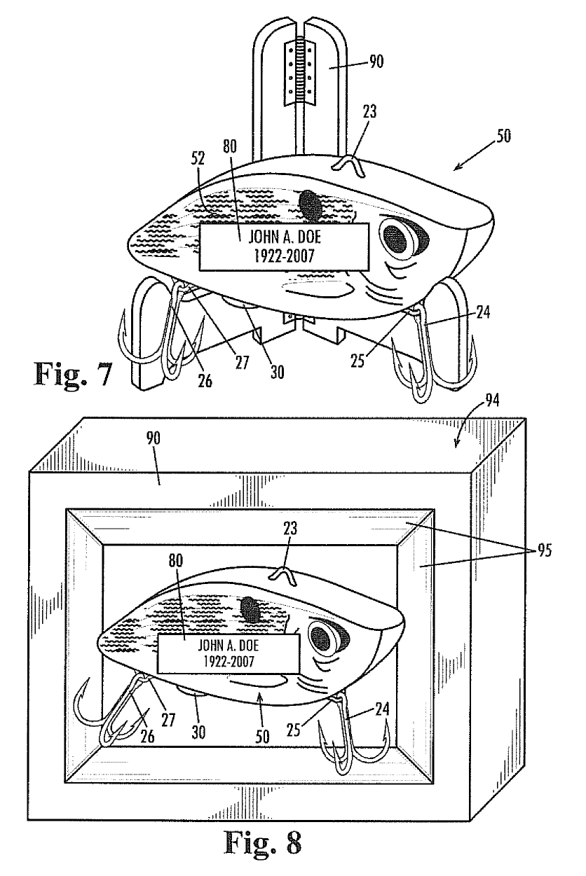

FIG. 5 illustrates the rear side of a urn, for instance, fishing lure urn 50. A sawtooth hanging bracket 70 may be affixed, using screws, nails, or adhesive, to the rear side of the urn 50. Such bracket 70 permits the urn 50 to be hung on a wall or in a shadow box (as in FIG. 8). Other types of brackets may instead be used, such as picture hanging brackets that may or may not be threaded with wire.

The front side of the urn 50 may, optionally, be provided with a commemorative plate 80, as shown in FIG. 6. The commemorative plate 80 may be made of any suitable material, including, but not limited to, plastic, aluminum, gold, silver, brass, bronze, or stainless steel. The commemorative plate 80 may be engraved or printed to include the name or initials of the deceased, the birth and death dates or years of the deceased, and/or a message to or about the deceased (e.g., “Beloved Father,” “Faithful Companion,” “Rest in Peace,” or “Gone Fishing”).

The commemorative urn (e.g., 50) may be displayed in a decorative stand 90, which is sized to accommodate the urn 50. The decorative stand 90 may then be displayed on a shelf or table of the surviving family member or friend, as a memento honoring the deceased and his love of fishing. Although illustrated with the hooks 24, 26 attached to the hollow body 52, the urn 50 may instead be exhibited without the hooks 24, 26 to reduce the likelihood of injury. The decorative stand 90 may be made of any material, such as wood, plastic, or metal, and may be chosen to match the urn 50 and/or the décor of the room in which the urn 50 will be kept. If the urn 50 is to be displayed thusly, the need for the hanging bracket 70 is obviated.

However, as shown in FIG. 8, the hanging bracket 70 may be particularly useful when the urn 40 is to be displayed in a shadow box 94. The lure urn 40 may be hung on a tack or small nail (not shown) within the shadow box 94. The walls 95 of the shadow box 94 may be sized according to the dimensions of the urn 50. Further, the shadow box 94 may be sized significantly larger than the dimensions of the urn 50, so that a photograph, poem or other literary tribute, or commemorative plate may be positioned within the shadow box 94, alongside the urn 50. Alternately, a commemorative plate (80) may be attached to the exterior frame 96 of the shadow box, rather than to the urn 50 itself.

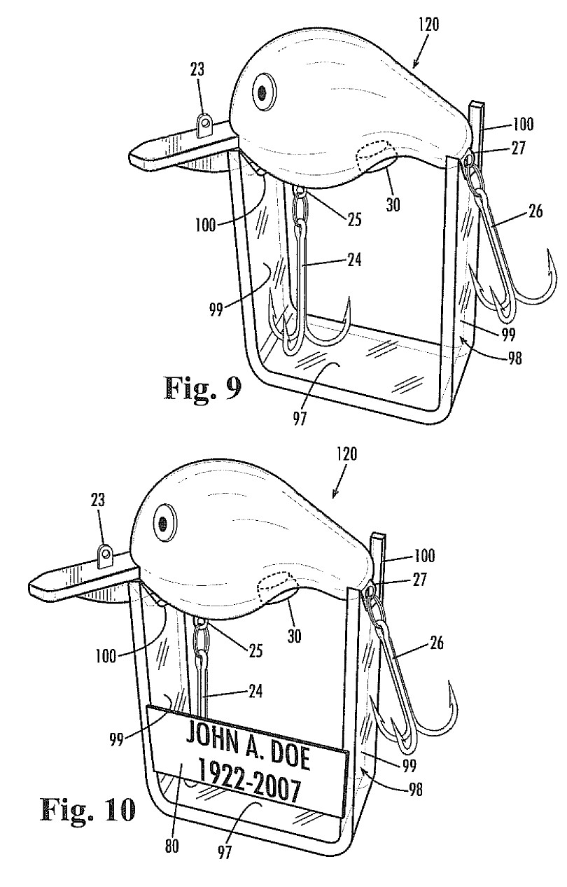

FIG. 9 illustrates a fishing lure urn 120 held in a stand 98. The stand 98 has a base 97 from which project vertically two sides 99. The sides 99 terminate at their distal ends in an arch-shaped opening 100, within which the respective ends of the urn 120 may be positioned. The stand 98 may be made of wood or another material, such as plexiglass, as desired to coordinate with the urn 120 or the furnishings of the room in which the urn 120 is to be displayed.

A variation of the stand 98 of FIG. 9 is shown in FIG. 10, in which a commemorative plate 80 has been attached to the stand 98. As illustrated, the commemorative plate 80 may be affixed to the vertically projecting sides 99 and may be inscribed as discussed above. Alternately, the commemorative plate 80 may be attached at some other location on the stand 98 or may be attached directly to the hollow body of the urn 120 (for example, as shown in FIG. 6).

The preceding discussion merely illustrates the principles of the present fishing lure urns. It will thus be appreciated that those skilled in the art will be able to devise various arrangements, which, although not explicitly described or shown herein, embody the principles of the invention and are included within its spirit and scope. Furthermore, all examples and conditional language recited herein are principally intended expressly to be only for pedagogical purposes and to aid the reader in understanding the principles of the inventions and the concepts contributed by the inventor(s) to furthering the art and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

This description of the exemplary embodiments is intended to be read in connection with the figures of the accompanying drawings, which are to be considered part of the entire description of the invention. In the description, relative terms such as “lower”, “upper”, “horizontal”, “vertical”, “above”, “below”, “up”, “down”, “top” and “bottom”, as well as derivatives thereof (e.g., “horizontally”, “downwardly”, etc.) should be construed to refer to the orientation as then described or as shown in the drawing under discussion. These relative terms are for convenience of description and do not required that the apparatus be constructed or operated in a particular orientation, unless otherwise indicated. Terms concerning attachment, coupling, and the like, such as “connected”, “attached”, or “interconnected”, refer to a relationship wherein structures are secured or attached to one another either directly or indirectly through intervening structures, as well as both movable or rigid attachments or relationships, unless expressly described otherwise.

The foregoing description provides a teaching of the subject matter of the appended claims, including the best mode known at the time of filing, but is in no way intended to preclude foreseeable variations contemplated by those of skill in the art.

We claim:

1. An urn comprising a fishing lure having a hollow body for receipt of cremation ashes therein and further having an underside defining an aperture therethrough; the urn further comprising a closure device configured to block the aperture and prevent the ashes from being dislodged.

2. The urn of claim 1, wherein the fishing lure resembles one of a fish and an insect.

3. The urn of claim 1, wherein the closure device is selected from the group consisting of a plug-type cap, a screw cap, and a sliding door.

4. The urn of claim 1, further comprising a mounting bracket.

5. The urn of claim 4, further comprising a shadowbox, the fishing lure being mounted, via the mounting bracket, within the shadowbox.

6. The urn of claim 5, further comprising a memorial plate affixed to the shadowbox, the memorial plate including at least one of the name of the deceased, the birth and death dates of the deceased, a message about the deceased, and a message to the deceased.

7. The urn of claim 1, further comprising a stand configured to display the fishing lure.

8. A method of memorializing a deceased loved one, the method comprising:
providing a fishing lure urn having a hollow body for receipt of a portion of the cremated ashes of the loved one therein, the hollow body further having an underside defining an aperture therethrough;
providing a closure device configured to block the aperture and prevent the ashes from being dislodged;
pouring the ashes of the loved one through the aperture into the hollow body; and
engaging the closure device with the aperture; and
displaying the resultant fishing lure urn.

9. The method of claim 8, wherein the fishing lure urn resembles one of a fish and an insect.

10. The method of claim 8, wherein the closure device is selected from the group consisting of a plug-type cap, a screw cap, and a sliding door.

11. The method of claim 8, further comprising providing a stand, wherein the fishing lure urn is displayed on the stand.

12. The method of claim 8, further comprising providing a mounting bracket on the fishing lure urn.

13. The method of claim 12, further comprising providing a shadowbox, wherein the fishing lure urn is displayed within the shadowbox.

14. The method of claim 13, further comprising providing a memorial plate, the memorial plate including at least one of the name of the deceased, the birth and death dates of the deceased, a message about the deceased, and a message to the deceased, and affixing the memorial plate to the shadowbox.
